(19) United States
(12) Patent Application Publication
(10) Pub. No.: US 2026/0311952 A1
(43) Pub. Date: Oct. 8, 2026

(54) IMPROVEMENTS IN AND RELATING TO X-RAY SOURCES

(71) Applicant: KRATOS ANALYTICAL LIMITED, Manchester, Greater Manchester (GB)

(72) Inventor: Simon PAGE, Manchester (GB)

(73) Assignee: KRATOS ANALYTICAL LIMITED, Manchester, Greater Manchester (GB)

(21) Appl. No.: 18/880,730

(22) PCT Filed: Jun. 27, 2023
(86) PCT No.: PCT/EP2023/067522

§ 371 Date: Jan. 2, 2025

(30) Foreign Application Priority Data
Jul. 4, 2022 (GB) 2209809.9

(51) Int. Cl. H01J 35/28; H01J 35/12

(52) U.S. Cl. CPC H01J 35/28; H01J 35/12; H01J 2235/1006; H01J 2235/1026; H01J 2235/1204; H01J 2235/1262

(57) ABSTRACT

An X-ray source is configured to generate X-rays (11) by electron impact upon an anode (2) and comprises an electron beam generator (5) for generating a beam of electrons (3) directed along a beam axis. A pivoting anode assembly (1) comprises a pivot (17) and an anode surface part (2) mounted upon the pivot for receiving electrons in the beam of electrons therewith to generate X-rays. A suspension assembly (19) is configured to apply to the pivoting anode assembly a restoring force to urge the pivoting anode assembly towards a quiescent position in which the anode surface part is static relative to the pivot. A displacer assembly (21) is configured to apply to the pivoting anode assembly a periodic displacing force to displace the pivoting anode assembly from the quiescent position. The position of the anode assembly is configured to oscillate about the quiescent position in a motion transverse to the beam axis in response to the periodic displacing force and the restoring force thereby to oscillate the anode surface part transversely across the beam axis.

This application claims priority from earlier application number GB2209809.9 filed 4 Jul. 2022, the contents and elements of which are herein incorporated by reference for all purposes.

### FIELD OF THE INVENTION

The present invention relates to X-ray sources configured to generate X-rays by electron impact upon an anode. Particularly, although not exclusively, the present invention relates to X-ray sources used in the field of X-ray photoelectron spectroscopy (XPS).

### BACKGROUND

X-ray sources typically take the form of a cathode opposed by an anode within a vacuum chamber (often referred to as a “tube”). The cathode is heated to emit electrons into the vacuum. A high voltage power source (e.g., several tens of kV to over 100 kV) is applied between the cathode and the anode to accelerate the electrons to the anode. This creates a flow of electrical current, known as the electron beam, through the tube. Electrons of the electron beam collide with the atoms forming the material of the anode (e.g., copper, molybdenum or tungsten). In doing so, the colliding beam electrons create inner shell holes, decelerate and scatter and, in doing so, emit X-rays in several processes. One such process known as bremsstrahlung: electromagnetic radiation produced by the acceleration or especially the deceleration of a charged particle after passing through the electric and magnetic fields of an atom. In addition, ‘line’ or ‘characteristic’ radiation is produced by the incident electrons ejecting an inner shell electron creating an inner shell vacancy which is then filled by an outer shell electron with the emission of a photon of energy equal to the energy difference between the energy levels of the outer shell and inner shell electrons. The spectrum of emitted X-rays depends on the anode material and the kinetic energy of the electrons in the electron beam, as determined by the accelerating voltage between the anode and cathode.

Only approximately 1% of the energy generated by the electron beam collision process is emitted as bremsstrahlung and ‘line’ X-rays. The rest of the energy is released as heat which is produced in a focal spot on the anode. The focal spot is where the electron beam is directed (e.g., focussed) to strike the anode, using electron optical elements disposed between the cathode and the anode for this purpose. The quantity of heat produced (E, Joules) in the focal spot is given by:

$$E = V \times I \times t$$

Here, V is the accelerating voltage (volts) between the anode and cathode, l is the electrical current (amps) of the electron beam through the tube, and t is the exposure time (seconds) of the given fixed point of the anode to the focal spot of the beam. A high temperature may be generated in the focal spot of a stationary anode. The focal spot temperature could reach greater than the melting point of the anode material and therefore damage the anode surface. However, by rotating an anode around an axis offset from the electron beam, prior art devices allow the electron beam to sweep over a circular path on the surface of the anode thereby reducing the exposure time of the given point of the anode to the focal spot of the beam damage to the anode. However, rotating anode arrangements are complex and difficult to implement in ultra-high vacuum environments for continuous operation in an economic manner. One example of the application of X-ray tubes is in X-ray photoelectron spectroscopy (XPS). This is a spectroscopic technique that exploits the photoelectric effect whereby X-rays from an X-ray source (typically the characteristic line radiation) are directed at a sample material under study and cause photoelectrons to be emitted from the surface of that sample. The technique can identify the elements that exist within or upon a sample material. In addition, the electronic structure of materials and the density of their electronic states can be deduced. The properties of a material may be deduced from a measurement, by a photoelectron detector, of the number of photoelectrons at each one of a range of different kinetic energies: these two quantities allow a photoelectron spectrum to be generated which contains spectral peaks diagnostic of the sample material.

The accuracy depends on several parameters such as photoelectron signal-to-noise ratio from a photoelectron detector and photoelectron peak intensity (i.e. spectral peak), amongst other things. It is known that by increasing the intensity of X-ray illumination upon a target sample, one is able to generate a higher flux of photoelectrons. This higher flux corresponds to a higher signal at a photoelectron detector and, therefore, a higher signal-to-noise ratio allowing improved measurement accuracy. Increased X-ray illumination requires increased electron beam current, l, in the electron beam incident on the anode. This brings with it the problems of anode heating and damage, identified above.

The present invention has been devised in light of the above considerations.

### SUMMARY OF THE INVENTION

At its most general, the invention concerns an anode for an X-ray source in which the anode is upon a pivot-mounted mechanical structure that is periodically displaced from a quiescent or fiducial position and returned to that position in an oscillating manner (e.g., a forced oscillation) by a suspension arrangement (e.g., sprung) that suspends the mechanical structure. This results in a simple arrangement that allows the electron beam of the X-ray source to sweep over a path on the surface of the anode by oscillating the anode relative to the electron beam thereby reducing the exposure time of the given point of the anode to the focal spot of the electron beam. This reduces the temperature rise at the surface of the anode. The speed and trajectory (e.g., length) of the path of the focal spot of the electron beam upon the anode surface may be accurately controlled by controlling the periodic displacement. By suitably arranging the mechanical structure and suspension arrangement to achieve a preferred mass distribution (e.g., moments of inertia), one may achieve an improved dynamical response to the periodic displacement.

In a first aspect, the invention may provide an X-ray source configured to generate X-rays by electron impact upon an anode comprising:
an electron beam generator for generating a beam of electrons directed along a beam axis;
a pivoting anode assembly comprising a pivot and an anode surface part mounted upon the pivot for receiving electrons in the beam of electrons therewith to generate X-rays;
a suspension assembly configured to apply to the pivoting anode assembly a restoring force to urge the pivoting anode assembly towards a quiescent position in which the anode surface part is static relative to the pivot;
a displacer assembly configured to apply to the pivoting anode assembly a periodic displacing force to displace the pivoting anode assembly from the quiescent position;
wherein the position of the anode assembly is configured to oscillate about the quiescent position in a motion transverse to the beam axis in response to the periodic displacing force and the restoring force thereby to oscillate the anode surface part transversely across the beam axis.

In this way, the dynamical interaction between the restoring force from the suspension system and the periodic displacing force of the displacer assembly, both acting about the same pivot of the pivoting anode assembly, determines the speed and trajectory of the path of point of impact of the electron beam on the anode surface. By controlling the frequency and/or magnitude of the periodic displacing force, and by controlling the restoring force from the suspension assembly, the position of the anode assembly can be made to oscillate with a desired dynamical response to the periodic displacement. A suitable mass distribution (e.g., moments of inertia) of the anode assembly may greatly enhance the energy efficiency and/or oscillation frequency of this dynamical response. The suspension assembly may comprise a sprung suspension arrangement. For example, the suspension assembly may comprise one or more springs configured to provide the restoring force.

Preferably, the pivot is fixed, or static, in position relative to the suspension assembly and/or relative to the displacer assembly. Preferably, the pivot comprises a single pivot axis such that the pivoting anode assembly is configured to pivot about the single pivot axis. A single pivot axis constrains the motion of the anode assembly and so a substantially linear motion of the anode surface (e.g., a motion along a very slightly curved arc), or a linear path of the trajectory of the path of point of impact of the electron beam on the anode surface. For example, the pivot may comprise a fixed or static axle or axis about which the anode assembly is configured to revolve, such as a hinge or bearing (e.g., flexure bearing). Alternatively, the pivot may comprise a universal joint. A universal joint may allow a longer path for the motion of the anode surface (e.g., looping or circular path, rather than an approximately linear path). Consequently, the path of the electron beam impact point on the anode surface may be made longer for a given angular deflection from the fiducial position. This may result in a lower averaged power density over that path.

Desirably, the pivot comprises one or more flexure bearings configured to flex about a pivot axis of the pivoting anode assembly. Flexure bearings have been found to be advantageous in providing an arrangement with negligible ‘backlash’. Flexure bearings also have a very long lifetime if the angular deflection and loads are kept within suitable limits. Suitable limits may be, for example, about ±6°, or preferably about ±5°, or more preferably about ±4°, or yet more preferably about ±3°, or even more preferably about ±2°. The pivoting anode assembly may be configured to limit the angular deflection within such limits.

The pivoting anode assembly may be configured to limit the load applied to the pivot (e.g., flexure bearing, or each bearing if more than one) to a load of less than about 650 lb (2891 N), or less than about 500 lb (2224 N), or preferably less than about 450 lb (2002 N) or less than about 425 lb (1890 N), e.g., less than about 403 lb (1793 N).

The pivot may comprise one or more flexure bearings configured with a diameter of between about 0.375 inches (0.952 cm) and about 0.625 inches (1.588 cm), such as about 0.5 inches (1.270 cm) for example. The pivot may comprise two pairs of flexure bearings configured and positioned with mutually orthogonal axes of rotation to form a universal joint which may be used to achieve desirable precision of motion of the pivoting anode assembly.

The flexure bearing(s) may comprise a single part including two rigid structures (e.g., one half-cylinder part concentrically within an outer cylinder part) rotatably joined by a thin bridging part of a flat resilient material which can be repeatedly flexed without disintegrating. The bridging part may be integrally formed with both the two rigid structures and may be their only connection to each other. The bridging part acts as a ‘hinge’ between the two rigid structures. Flexure bearings have the advantage, in dynamic terms, that they have essentially zero (or negligibly low) friction and therefore do not significantly contribute to damping of the harmonic oscillatory motion of the anode assembly. Because flexure bearings do not require lubrication they may be employed in a vacuum, as may be desirable for the X-ray source. Alternatively, the pivot may comprise an elastically resilient member (e.g., a spring) upon which the anode assembly is mounted (e.g., upon an end of the spring). This elastically resilient member may also serve as the suspension assembly (or at least a part of it).

For example, the pivoting anode assembly may be comprise a pivot mounting which is not an axle but, instead, is a spring member (e.g., coil spring or helical spring, or a torsion spring) which may be deformed in a direction transverse to its long axis. The pivot mounting may be a mounting on the spring member, e.g., at an end of for example, or at a position along its length. The deformation of the spring member may flex or bend to allow the anode assembly to pivot. In some examples, the spring member of the pivot may act not only as the pivot but also as the suspension assembly. The motion of the surface of the anode surface part may be adequately controlled so as to avoid significant longitudinal motion. For example, if the spring member comprises a coil spring or helical spring, the displacer assembly may be configured to apply to the pivoting anode assembly a periodic displacing force to displace the pivoting anode assembly to limit the displacement of the spring member thereby to limit excitation of extension and contraction of the spring member. In this way, the suitable limits or constraints may be applied to the extreme displacement positions of the anode surface part. For example, a torsion spring may function as both the pivot and to provide a restoring force to urge the pivoting anode assembly to its quiescent position when the anode surface part reaches an extreme displacement position (e.g., angular displacement).

Desirably, the pivoting anode assembly is configured to oscillate about the quiescent position such that a point of intersection of the electron beam axis upon the anode surface part scans a substantially linear path across the anode surface part. In this way, the trajectory of the path of the focal spot of the electron beam upon the anode surface may be accurately controlled to be linear by controlling, or constraining, the periodic displacement of the anode assembly to be constrained to be in (or parallel to) a plane of oscillation: that plane of oscillation may contain the path of the focal spot of the electron beam upon the anode surface. A particular benefit of this arrangement is that the position of the anode assembly may be configured to be adjustably displaceable in a direction transverse to the plane of oscillation thereby to allow the oscillatory motion of the displaced anode assembly to be constrained to be in (or parallel to) a new plane of oscillation which is substantially parallel to the prior plane of oscillation. This allows the path of the focal spot of the electron beam to traverse a ‘fresh’ new surface region of the anode surface as and when the old surface region of the anode surface previously traversed by the focal spot of the electron beam becomes unsuitable for use e.g., due to accumulated electron impact damaged.

For example, the X-ray source may comprise a transverse displacer configured to adjustably displace the pivoting anode assembly in a direction transverse to a plane of oscillation of the anode surface part. In some aspects, the transverse displacer may comprise one or more stepper motors or actuators configured to transversely displace the pivoting anode assembly and the suspension assembly (preferably slowly) to different positions on a plane parallel to the anode surface part. This allows fresh areas of the anode surface to be used once particular areas have been consumed thereby reducing the frequency of anode replacement. Accordingly, the X-ray source may comprise a transverse displacer configured to adjustably displace the position of the anode assembly in a direction transverse to the plane of oscillation to an adjusted position allowing the anode assembly to oscillate in (or parallel to) a new plane of oscillation which is substantially parallel to the plane of oscillation from which displacement is made. The transverse displacer may be configured to adjustably displace the position of the anode assembly in a direction which is substantially parallel to the anode surface (e.g., the anode surface May be planar). Desirably, the transverse displacer may be configured to adjustably displace the position of the anode assembly in a direction such that the focal spot of the electron beam continues to coincide with the anode surface, or such that the distance between the electron source and the point of impact of the electron beam on the anode surface, remains substantially unchanged.

The surface of the anode part presented towards the electron beam generator may be substantially flat or planar. As such, lateral parts of that surface may periodically move closer to the electron beam generator as the surface tips or tilts relative to the electron beam. Those lateral parts include the changing point upon which the electron beam impacts. Hence, that changing point of anode surface may periodically advance and retract along the electron beam axis. Desirably, the X-ray source comprises a longitudinal displacer configured to adjustably displace the pivoting anode assembly in a direction substantially parallel to a plane of oscillation of the anode surface part to adjustably displace the anode surface part in a direction selectively longitudinally towards or longitudinally away from the electron beam generator. The longitudinal displacer may be configured to adjustably displace the pivoting anode assembly in such a way as to make substantially constant the separation between the electron beam generator and the point of impact of the electron beam upon the anode surface part during pivoting of the anode assembly. In this way, the otherwise changing separation may be made substantially constant.

Preferably, the X-ray source comprises a position sensor or transducer configured to determine a position of the anode surface part during oscillation thereof. The position sensor or transducer may be configured to determine an angular position of the pivoting anode assembly (e.g., determining substantially continuously, or by sampling the position at successive discrete times at a sufficiently high sampling rate as to be quasi-continuous). The position of the anode surface varies according to the angular position of the pivoting anode assembly to which it is attached. The location of any given fixed point on the anode surface may be constrained to lie upon an arc trajectory or path defined by the angular position of the pivoting anode assembly and the radial distance of the given point from the pivot. However, the longitudinal displacer may be configured to adjustably displace the pivoting anode assembly in response to the determined position of the anode surface part, or in response to a determined angular position of the pivoting anode assembly, or in response to another determined position measurement proportional to angular position of the pivoting anode assembly, in such a way as to make substantially constant the separation between the electron beam generator and the point of impact of the electron beam upon the anode surface part during pivoting of the anode assembly. In this way, the otherwise changing separation may be made substantially constant.

The consequence of this is that because the separation between the electron beam generator (e.g., electron gun) and the pivot is made to appropriately vary longitudinally during oscillation of the pivoting anode assembly, in normal use, then the separation between the point of impact of the electron beam and the electron beam generator is made substantially constant. Since the electron beam generator may typically comprise electron optics configured to focus the electron beam into a focal spot coinciding with the surface of the anode part, any variation in the separation between the point of impact of the electron beam and the electron beam generator would mean that the anode surface would move away from the focal spot of the electron beam, possibly resulting in the size of the electron beam on the anode surface change. The longitudinal displacer may prevent this occurring.

The longitudinal displacer may comprise a stepper motor or an actuator (e.g., a piezoelectric element) configured to adjustably displace the pivoting anode assembly longitudinally (e.g., in a direction selectively towards or away from the anode surface part or towards or away from the electron beam generator). For example, the longitudinal displacer may comprise a position sensor or transducer configured, such as mentioned above, to generate a signal/information representing an angular position of the pivoting anode assembly, relative to the quiescent position. The longitudinal displacer may be configured to use this angular information to control the position (extension or retraction) of the actuator or stepper motor in proportion to the angular position.

It is to be noted that the angular position of the pivoting anode assembly translates directly into a corresponding position of the point of impact of the electron beam upon the anode surface part, relative to the position of the point of impact when the pivoting anode assembly is in the quiescent position. For example, when the pivoting anode assembly is oscillating it will periodically pass through the position it would otherwise have when quiescent (i.e., a fiducial position). The longitudinal displacer may be configured displace the pivoting anode assembly in a first direction away from the electron beam generator when the pivoting anode assembly is moving away from the fiducial position, and to displace the pivoting anode assembly in a second direction towards the electron beam generator (i.e., opposite to the first direction) when the pivoting anode assembly is moving towards the fiducial position.

For example, when the oscillating position of the pivoting anode assembly momentarily coincides with the quiescent position, then let the radial distance from the pivot to the point of impact of the electron beam upon the surface of the anode part be l₀. Let the radial distance from the pivot to the point of impact of the electron beam upon the surface of the anode part be l when the angular position of the pivoting anode assembly relative to the quiescent position, is θ. As the anode tilts through θ the distance from the pivot point to the electron beam impact point increases from l₀ to l₀sec (θ) so the rate of change differential defines the rate of change of the radial distance as a function of changing angular position, which is:

$$\frac{dl}{d θ} = lo \frac{sin θ}{{( cos θ )}^{2}}$$

The longitudinal displacer may be configured to apply a changing longitudinal displacement (Δ) to the pivoting anode assembly such that the rate of change of the longitudinal displacement (Δ) as a function of changing angular position is:

$$\frac{d Δ}{d θ} = - \frac{dl}{d θ} = - lo \frac{sin θ}{{( cos θ )}^{2}}$$

The effect is to counter-balance the changes in the radial distance from the pivot to the point of impact of the electron beam upon the surface of the anode part, that are caused by the changing angular position of the pivoting anode. Integrating this rate of change of the longitudinal displacement (Δ) as a function of changing angular position gives the value of the value of the longitudinal displacement (Δ) at a given angular position (θ), as:

$$Δ = - {l}_{0} ( sec ( θ ) - 1 )$$

The negative sign indicates that the displacement is in the aforementioned first direction away from the electron beam generator when the pivoting anode assembly is moving away from the fiducial position, i.e., when 0 increases in magnitude. The longitudinal displacer may be configured to apply a changing longitudinal displacement (Δ) to the pivoting anode assembly according to this equation.

The spatial distribution of the mass of the pivoting anode assembly may be asymmetrical with respect to the pivot axis. For example, separate parts of the pivoting anode assembly may be located at opposite sides of the pivot. In this arrangement, the pivot may be located between opposite ends of the anode assembly (e.g., see FIG. 5 in which some of the pivoting anode structure is to the right of the pivot 17, notably certain water-cooling pipes and connections).

Alternatively, substantially all of the mass of the pivoting anode assembly may be located at the same one side of the pivot. In this alternative arrangement, the pivot may be located at one end of the anode assembly (e.g., see FIG. 1).

Desirably, the location of the centre of mass of the pivoting anode assembly is closer to the pivot than it is to the anode surface part. This has been found to enable faster oscillation frequencies of oscillatory motion of the anode assembly, due to the lower moment of inertia. The centre of mass of the pivoting anode assembly is located between the pivot and the anode surface part. Alternatively, the centre of mass of the pivoting anode assembly and the anode surface may be located at opposite sides of the pivot. Careful balancing of moments of inertia and the suspension assembly (e.g., spring constants of springs, if used in the suspension assembly) has been found to improve sensitivity and mechanical efficiency. Preferably, the anode assembly is configured to position most of its mass close to the pivot/rotation axis with the result that the moment of inertia will be relatively low. This means that the relatively high vibration frequency needed to minimise the peak instantaneous temperature rise of the anode surface can be achieved with modest restoring forces from the suspension assembly (e.g., modest spring constants). This means that the resonant frequency of oscillatory motion of the anode assembly can be adjusted up or down by changing the restoring forces (e.g., spring constants) of the elements (e.g., spring(s)) up or down respectively.

It is desirable to achieve as high a resonant frequency as possible within the mechanical limitations of the overall structure. An aim of achieving a high resonant frequency is to limit the peak temperature within an electron beam impact spot as it sweeps across the anode surface. It is desirable, to keep the centre of mass of the pivoting anode assembly as close to the pivot point as possible within the other constraints of the structure.

Preferably, the pivoting anode assembly comprises a coolant channel configured for conducting coolant fluid (e.g., water) in a direction away from the pivot towards the anode surface part. The coolant channel is preferably also configured for conducting coolant fluid back towards the pivot and away from the anode surface. This has been found to achieve a desired effect such that the mass and flow of the coolant has been found to have only a small the influence on the oscillatory motion of the anode assembly (e.g., influence on its moment of inertia). This avoids, or reduces, a disturbing effect on the oscillatory motion due to the flow of air spaces within the coolant flow.

Preferably, the suspension assembly and the displacer assembly are configured such that the displacer assembly is operable to impose a driven oscillatory motion of the anode assembly at a frequency of oscillatory motion corresponding to a resonant frequency. Preferably the range of oscillation frequencies may be from about 10 Hz to about 1 kHz. Preferably, the range of path lengths of the electron beam focal spot upon the anode surface may be any value up to about 10 mm. Preferably, the length of the anode assembly as measured from the pivot point to the anode surface may be in the range of about 50 mm to about 600 mm.

Preferably, the displacer assembly is configured to apply to the pivoting anode assembly said periodic displacing force with a periodicity corresponding to a resonant frequency of oscillation of the pivoting anode assembly.

Desirably, the suspension assembly comprises one or more springs configured to apply the restoring force wherein the resonant frequency of oscillation is substantially proportional to the value of spring constant(s) of the one or more springs. The desired range of spring constants for such spring(s) may be calculated according to the desired oscillation frequency and with consideration of the consequent loading of the pivot assembly. Optionally, in place of such spring(s), piezoelectric actuators could be used and selected for their spring rate and actuation force. Similarly, in place of such spring(s), pneumatic actuators may be used where the pressurised gas may act as the spring element.

The resonant frequency of the system depends on the value of the moment of inertia of the masses supported by the pivot and the value(s) of the spring rates/constants of the supporting springs of the suspension system. By an appropriate choice of these values, a desired resonant frequency of oscillatory motion of the anode assembly can be achieved.

Preferably, the anode surface part is electrically floating and held at a positive potential of not less than about 5 kV, or more preferably not less than about 10 kV, or yet more preferably in the range about 5 kV to about 20 kV (e.g., about 15 kV). This simplifies the demands on the control electronics for the electron beam generator (e.g., electron gun) of the system because it is essentially very near local earth potential if an electron impact energy of about 15 keV is required. It has the added advantage that backscattered and secondary electrons from the anode surface are not energetic enough to reach surrounding earth potential regions (e.g., in XPS this would be the analysis chamber and sample region). Consequently, in some embodiments, there is no need for the window enclosing the anode surface within a volume of the X-ray source as might otherwise be the case for the purposes of blocking backscattered and secondary electrons from entering the ambient environment beyond the X-ray source.

The displacer assembly preferably comprises one or more actuators, and more preferably comprises a single actuator. The actuator(s) may comprise a piezo-electric actuator. The displacer assembly may be configured to apply the periodic displacing force in a direction substantially parallel to the direction of a restoring force applied by the suspension assembly. For example, if the displacer assembly comprises a linear actuator, and if the suspension assembly comprises one or more linear (e.g., helical) springs, then the axis of extension/retraction of the actuator may be substantially parallel to the longitudinal axis of the one or more linear springs. A particular advantage of this arrangement is convenience in the light of the constraints of the other parts of the instrument. Alternatively, the displacer assembly may be configured to apply the periodic displacing force in a direction transverse to the direction of a restoring force applied by the suspension assembly.

The displacer assembly may be configured to apply the periodic displacing force to the anode assembly at a position that is laterally offset from the pivot, such that the periodic displacing force generates a periodic displacing torque to the anode assembly about the pivot. The position of the actuator may be selected such that the amplitude of the required motion of the actuator corresponding to the required amplitude of motion of the anode surface is within a desirable range.

The displacer assembly may be configured to apply to the pivoting anode assembly the periodic displacing force to apply a torque to the pivoting anode assembly at a location thereon between the anode surface part and the pivot.

The displacer assembly may be configured to apply to the pivoting anode assembly the periodic displacing force to apply a torque to the pivoting anode assembly at a location thereon wherein the pivot is located between said location of the applied torque and the anode surface.

It is to be understood that the aspects and features of the invention described above implement the invention in terms of an X-ray source. However, it is intended that the invention may also, or alternatively, be made and sold as an anode device not including the electron beam generator but configured for use within an X-ray source that does have an electron beam generator for generating a beam of electrons directed along a beam axis to the anode surface part. In other words, each of the aspects and features of the X-ray source described above regarding the invention in its first aspect apply equally to the invention in its second aspect with the electron beam generator omitted.

For example, in a second aspect, the invention may provide an anode device for an X-ray source having an electron beam generator for generating a beam of electrons directed along a beam axis for use in generating X-rays by electron impact upon the anode device, the anode device comprising:
a pivoting anode assembly comprising a pivot and an anode surface part mounted upon the pivot for receiving electrons in a beam of electrons therewith to generate X-rays;
a suspension assembly configured to apply to the pivoting anode assembly a restoring force to urge the pivoting anode assembly towards a quiescent position in which the anode surface part is static relative to the pivot;
a displacer assembly configured to apply to the pivoting anode assembly a periodic displacing force to displace the pivoting anode assembly from the quiescent position;
wherein the position of the anode assembly is configured to oscillate about the quiescent position in a motion transverse to the beam axis in response to the periodic displacing force and the restoring force thereby to oscillate the anode surface part transversely across the beam axis.

The invention in this aspect may be made and sold as an ‘anode device’: i.e., as a package comprising the pivoting anode assembly, the suspension assembly and the displacer assembly but without the electron gun. The ‘anode device’ may be inserted into a pre-existing X-ray apparatus that already has an electron beam generator, as a replacement/upgrade to the anode previously within the pre-existing X-ray apparatus. This allows X-ray gun products to be upgraded with this anode assembly.

It is to be understood that the aspects and features of the invention described above implement a corresponding method of generating X-rays, which is encompassed by the invention. For example, in a third aspect, the invention may provide a method to generate X-rays by electron impact upon an anode, the method comprising:
generating a beam of electrons directed along a beam axis;
receiving electrons from the beam of electrons at an anode surface part thereby generating X-rays, wherein the anode surface part is mounted upon a pivoting anode assembly which comprises a pivot and which is mounted upon a suspension assembly;
applying to the pivoting anode assembly a restoring force via the suspension assembly to urge the pivoting anode assembly towards a quiescent position in which the anode surface part is static relative to the pivot;
applying to the pivoting anode assembly a periodic displacing force to displace the pivoting anode assembly from the quiescent position;
whereby the position of the anode assembly is oscillated about the quiescent position in a motion transverse to the beam axis in response to the periodic displacing force and the restoring force, thereby oscillating the anode surface part transversely across the beam axis.

In this way, the invention may provide an apparatus and method for increasing the maximum electron beam power density that an anode part can withstand without damage, this being achieved by rapid lateral vibration of the anode surface so as to spread out the heat dissipation on the anode surface thereby allowing a higher total power load for a given surface temperature. This may be used in any application when a more intense X-ray beam, generated by electron impact on a target material, is required than a fully stationary anode would allow. The invention may provide an electron impact X-ray sources for use in the field of XPS, where the desire for high signal levels for rapid XPS analysis leads to the use of high electron beam power densities. In prior art devices, this then leads to a large temperature rise at the anode surface which in the extreme leads to melting and subsequent failure of the metallic surface layer. Current commercial x-ray sources in XPS instruments operate with the anode in a fixed position. In contrast, the invention permits the anode structure to be vibrated rapidly laterally beneath the electron beam so as to expose a larger area of the anode surface which then lowers the average power density. The anode surface can then withstand a higher total power before damage occurs and this leads to an increase in the XPS signal intensity over what might otherwise be achievable by the electron beam generator. The position of the electron beam generator is preferably fixed in space (i.e., relative to the pivot) such that the position of the electron beam is likewise fixed in space. Consequently, the generated X-rays originate from an area determined by the lateral size of the electron beam rather than the lateral size of the area on the anode surface illuminated by the electron beam.

In XPS the signal intensity at small analysis areas is a key metric for a commercial XPS instrument performance and competitiveness. Various strategies are employed to achieve a high intensity including highly efficient electron optical systems to collect as many of the emitted photoelectrons as possible to measures to maximise the heat dissipation capabilities of the anode via use of high velocity water flows within the anode structure and use of embedded high thermal conductivity diamond in the area impacted by the electron beam. Even with these measures the surface temperature of the anode can reach the melting point of the anode coating (typically aluminium) quite easily which then leads to rapid degradation of the metal surface. As is well known very high temperatures can be achieved by electron beam welding of high melting point materials, so it is no surprise that aluminium can be readily melted by a focussed electron beam.

It is well known in the art that spreading the electron beam out over that anode surface lowers the power density and hence the anode surface temperature. A common way of achieving this is to use a rotating anode structure. This allows the electron beam to be spread around the perimeter of an anode disc while keeping the apparent size of the X-ray source to the required size closely related to that of the impacting electron beam. These systems often have high melting point materials and low duty cycle to avoid the need for continuous cooling. In the case of XPS instrumentation, continuous operation is necessary due to the sometimes long acquisition times and so continuous cooling is necessary. This brings with it difficult technological problems of cooling an anode structure rotating at high speed in ultra-high vacuum (UHV) conditions.

The invention permits an increase by a factor of up to about 6, or more, in the electron beam power level that the X-ray source can be run at, as compared to prior art systems, and this brings significant commercial benefit. The invention permits the anode to be rapidly vibrated in a direction parallel to the anode surface. Typically, in commercial XPS instrumentation, the electron beam may be 150 μm diameter and so vibration of the anode with a vibration amplitude of ‘A’ mm would allow this the power being delivered into this 150 μm diameter to be spread out over an area of 150×A×1000 μm² plus the area of the spot. For example, if A=1, this permits approximately 9.5 times the area of the anode surface to be illuminated with constant electron beam intensity. This would then allow an increase of up to about 9.5 times in the electron beam power and hence X-ray intensity generated.

The pivoting anode assembly may be an elongated structure (e.g., a cylindrical structure) with the anode surface located at one longitudinal end thereof and the pivot located at, or adjacent to, the opposite longitudinal end thereof. For example, the longitudinal length of the pivoting anode assembly may be at least about 50 mm long, or at least about 100 mm long, or at least about 150 mm long, or at least about 200 mm long, or at least about 250 mm long, or at least about 300 mm long, or at least about 350 mm long, or at least about 400 mm long, or at least about 450 mm long. Most preferably, the longitudinal length of the pivoting anode assembly is in the range of about 50 mm to about 500 mm. For example, the longitudinal length of the pivoting anode assembly may be in the range of about 100 mm to about 450 mm, or about 200 mm to about 500 mm, or more preferably about 250 mm to about 400 mm, e.g., about 300 mm long.

The X-ray source according to any aspect may be configured such that the anode surface part, in use, is electrically floating and held at a positive potential (e.g., of not less than 5 kV). Alternatively, the X-ray source according to any aspect may be configured such that the anode is at ground potential (earth) and the electron emitter (cathode) in the electron gun is at a negative potential. The value of the negative potential may be selected to be sufficiently high so as to provide the required impact energy for X-ray generation. This version of the x-ray source may be used to directly irradiate a specimen with x-rays e.g., where the analysis application will accept both characteristic radiation and bremsstrahlung radiation.

In a further aspect, the invention may provide an X-ray monochromator comprising the X-ray source disclosed according to any aspect may herein. The ability of the invention to compensate for movements of the X-ray source spot (i.e., the electron beam impact spot on the anode surface) caused by motion of the anode means that the invention is able to greatly reduce variations in the intensity, energy or positional change of the reflected X-ray spot on the surface of a sample being irradiated with X-rays from the X-ray source, in use.

To produce a beam of X-ray radiation with a narrowed wavelength distribution one may use a monochromator optic element (e.g., single-crystal). A monochromator optic element works by receiving X-rays from an X-ray source and reflecting those incident X-ray wavelengths that obey Bragg's Law. This allows one to select a defined wavelength of the X-ray radiation for a further purpose on a dedicated instrument or beamline. In this way, an X-ray monochromator operates through a diffraction process according to Bragg's law. X-ray monochromator optic elements are analogous to grating monochromators and spectrometers in the visible portion of the spectrum. An X-ray monochromator optic element may comprise a selected crystal lattice structure for this purpose. If the lattice spacing for a crystal is accurately known, the observed angles of diffraction can be used to select X-ray wavelengths. Because of the sensitive wavelength dependence of Bragg reflection exhibited by certain materials (e.g., quartz), a small portion of a continuous spectrum of radiation can be isolated. This isolated spectral portion is considered to be effectively monochrome i.e., it has a narrower energy spread than the characteristic X-ray line from which it has been isolated. In addition, if the crystal lattice structure is bent into an appropriate shape the isolated X-rays may be directed into an intense focussed spot to be used for subsequent XPS analysis.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic cross-sectional view of an X-ray source;

FIG. 2A shows a schematic cross-sectional view of a pivoting anode assembly of an X-ray source when at each of two different angular displacements;

FIG. 2B shows a graph of a longitudinal displacement applied to the pivoting anode assembly of FIG. 2A, as a function of the angular displacement thereof required to reduce the value of the separation between an electron gun and its electron beam impact point upon the anode, substantially to zero;

FIG. 3A shows a schematic cross-sectional view of an X-ray source;

FIG. 3B shows a schematic cross-sectional view of an X-ray source;

FIG. 4 shows a view of an X-ray source;

FIG. 5 shows a cross-sectional view of the X-ray source of FIG. 4;

FIG. 6A shows a schematic view of the mechanical and dynamical relationship between elements of a pivoting anode assembly;

FIG. 6B shows a graph of a resonance in the angular displacement of the pivoting anode assembly of FIG. 6A in response to application of a periodic displacement force as a function of the angular frequency of the displacement force.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

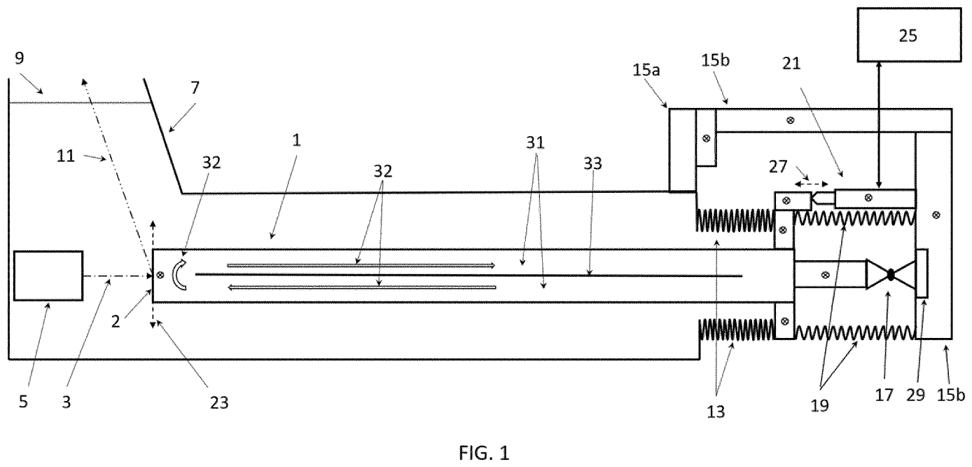

FIG. 1 shows a schematic cross-sectional view of an X-ray source, according to an embodiment of the invention. The X-ray source is configured to generate X-rays 11 by impact of a beam of electrons 3 upon a surface part of an anode 2. The X-ray source comprises an electron beam generator 5 for generating a beam of electrons 3 directed along a beam axis, to the anode 2. The anode 2 is mounted upon a terminal end of a pivoting anode assembly 1 for receiving electrons in the beam of electrons 3 therewith to generate X-rays. The anode surface part is electrically floating and held at a positive potential of not less than 5 kV. A base end of the pivoting anode assembly is mounted upon a pivot 17 comprising one or more flexure bearings configured to flex about a pivot axis of the pivoting anode assembly. In alternative arrangements, the anode is at ground potential and the electron emitter in the electron gun is at a high negative potential so as to provide the required impact energy for X-ray generation. A high voltage insulator (not shown on FIG. 1) may be provided for the pivoting anode assembly 1, if desired, to insulate the anode to maintain its potential at ground potential in any appropriate manner such as would be readily apparent to the skilled person.

The X-ray source includes a suspension assembly 15b comprising a plurality of springs laterally offset from the pivot 17 and configured to apply to the pivoting anode assembly 1 a restoring force to urge the pivoting anode assembly towards a quiescent position (as shown in FIG. 1) in which the anode surface part 2 is static relative to the pivot 17. A displacer assembly 21 is configured to apply to the pivoting anode assembly 1 a periodic displacing force 27 to displace the pivoting anode assembly 1 from the quiescent position. Consequently, the angular position of the pivoting anode assembly 1 is configured to oscillate about the quiescent position in a motion transverse to the beam axis 3 in response to the periodic displacing force 27 and in response to the simultaneous restoring force from the suspension springs 19. This causes the pivoting anode assembly to oscillate (in directions 23) the anode surface part 2, at its terminal end, transversely across the beam axis 3 of the electron beam.

The pivoting anode assembly thereby oscillates about the quiescent position such that a point of intersection of the electron beam axis upon the anode surface part 2 scans a substantially linear path across the anode surface part. The pivot 17 comprises a single pivot axis such that the pivoting anode assembly pivots about that single pivot axis when its angular position is caused to oscillate. The angular position may be considered to be an angle subtended at the pivot by the longitudinal axis of the pivoted anode assembly 1 relative to the longitudinal axis of the anode assembly 1 when it its quiescent position.

Notably, the spatial distribution of the mass of the pivoting anode assembly 1 is asymmetrical with respect to the pivot axis of the pivot 17. In this example, the position of the centre of mass of the pivoting anode assembly 1 is located between the pivot 17 and the anode surface part 2. The location of the centre of mass of the pivoting anode assembly is closer to the pivot than it is to the anode surface part. The pivoting anode 1 is elongated in shape such that its longitudinal dimension, in the direction of its longitudinal axis extending from the pivot 17 to the anode surface part 2, exceeds its dimension in any direction perpendicular to the longitudinal axis. In one example, the pivoting anode assembly may be about 100 mm in length, with a maximum lateral dimension (width) of about 70 mm. Conversely, in other examples, the pivoting anode assembly may be about 400 mm in length, with a maximum lateral dimension (width) of about 70 mm.

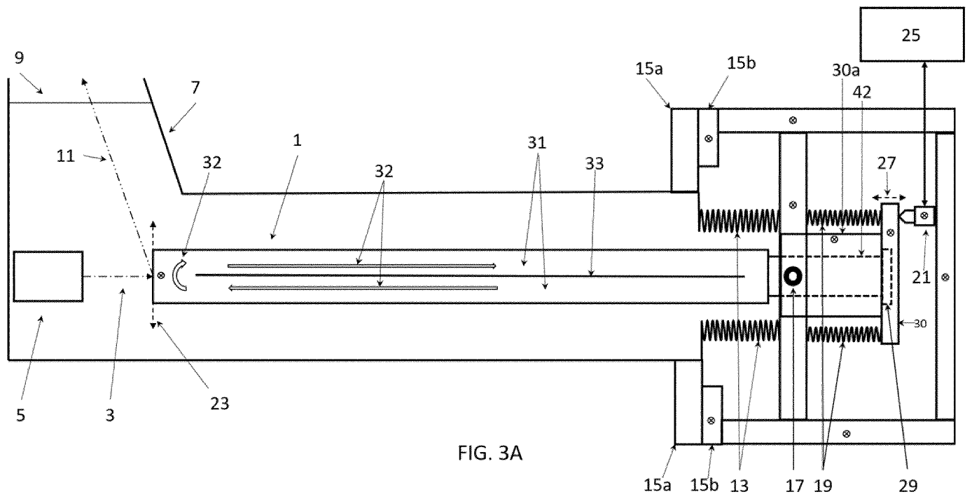

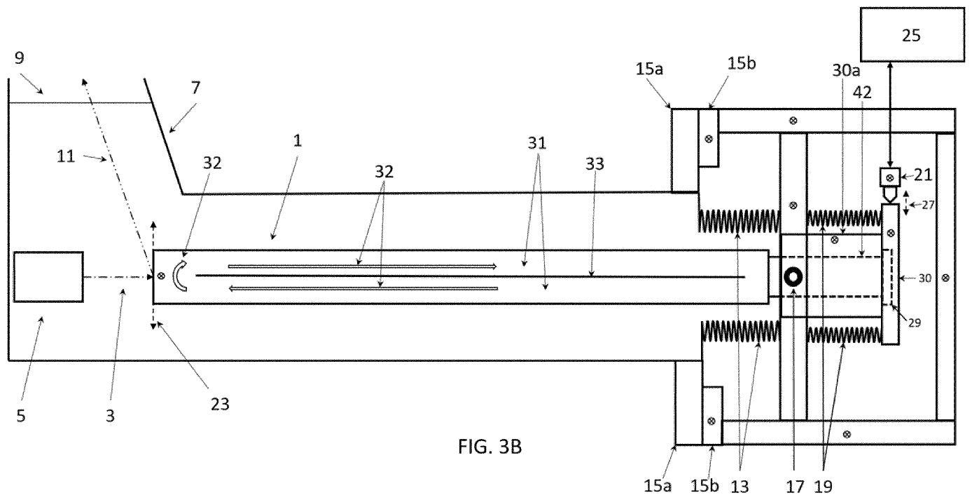

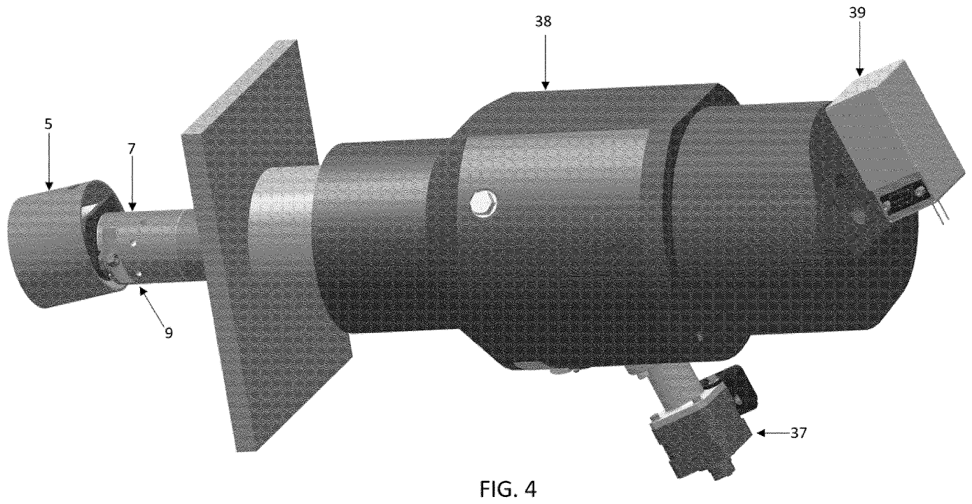

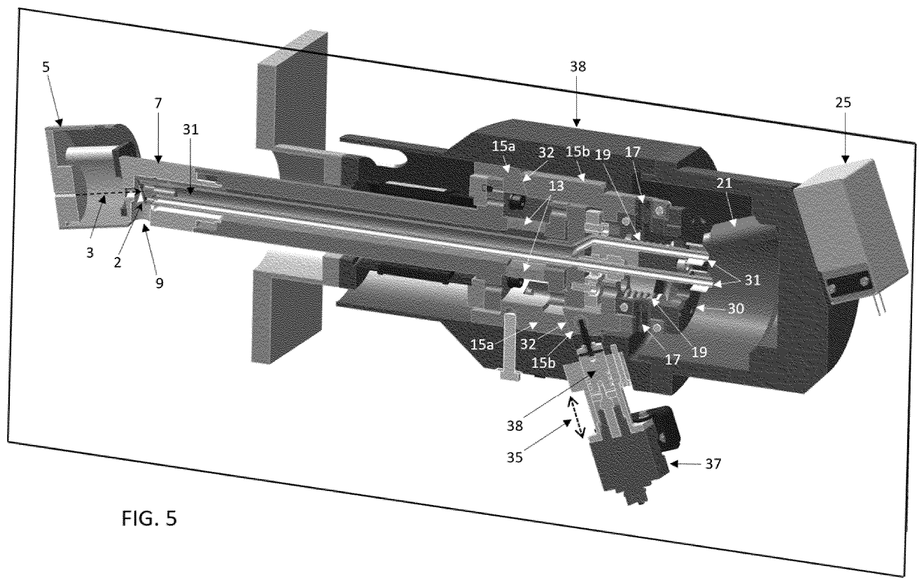

In other embodiments, such as shown in FIG. 3, FIG. 4 and FIG. 5, the position of the centre of mass of the pivoting anode assembly 1 and the position of the anode surface part 2 are located at opposite sides of the pivot, with the location of the centre of mass of the pivoting anode assembly still being closer to the pivot than it is to the anode surface part.

The displacer assembly is configured to apply to the pivoting anode assembly a periodic displacing force with a periodicity corresponding to a resonant frequency of oscillation of the pivoting anode assembly. The periodic displacing force is applied at a location upon the pivoting anode assembly that is laterally offset from the longitudinal axis of the pivoting anode assembly, and which is also longitudinally offset from the pivot in a direction towards the anode surface part. The result is to generate a torque to the pivoting anode assembly at a location thereon between the anode surface part and the pivot. In other words, the pivot is further from the anode surface part than the location of the applied force. In other embodiments, such as shown in FIG. 3, FIG. 4 and FIG. 5, the periodic displacing force applies a torque to the pivoting anode assembly at a location thereon such that the pivot is located between the location of the applied torque and the location of the anode surface. In other words, the pivot is closer to the anode surface part than the location of the applied force in these other embodiments.

The suspension assembly comprises one or more springs configured to apply the restoring force. The resonant frequency of oscillation is substantially proportional to the value of combined spring constant(s) of the one or more springs. In the example of FIG. 1, two springs are employed, in which the two springs are mechanically coupled to a base end of the pivoting anode assembly each at a position that is laterally offset from the longitudinal axis of the pivoting anode assembly and the pivot 17 (the longitudinal axis passing through the pivot). The two springs 19 share the same dimensions and spring constant. The displacer assembly 21 comprises a single actuator, such as a piezo-electric actuator and is configured in communication with a control unit 25 arranged to issue to the actuator control signals to control the extension and retraction of the actuator in such a way as to control both the amplitude of the periodic displacements to be applied by the actuator and their frequency.

In all embodiments of the invention, the appropriate positioning of the centre of mass of the pivoting anode assembly, relative to the pivot, has significant benefits in reducing the moment of inertia of the pivoting anode assembly to permit rapid oscillatory motion 23 of the anode surface part 2, with large amplitudes of angular displacement, in response to a relatively small periodic displacement at a resonant frequency of the mechanical system comprising the pivoting anode assembly and the suspension assembly mechanically coupled to it.

The moment of inertia, otherwise known as the mass moment of inertia, angular mass, second moment of mass, or most accurately, rotational inertia, of a rigid body is a quantity that determines the torque needed for a desired angular acceleration about a rotational axis, akin to how mass determines the force needed for a desired acceleration. It depends on the body's mass distribution and the axis chosen, with larger moments requiring more torque to change the body's rate of rotation. For a point mass the moment of inertia is simply the mass times the square of the perpendicular distance to the axis of rotation. The moment of inertia of a rigid composite system is the sum of the moments of inertia of its component subsystems (all taken about the same axis).

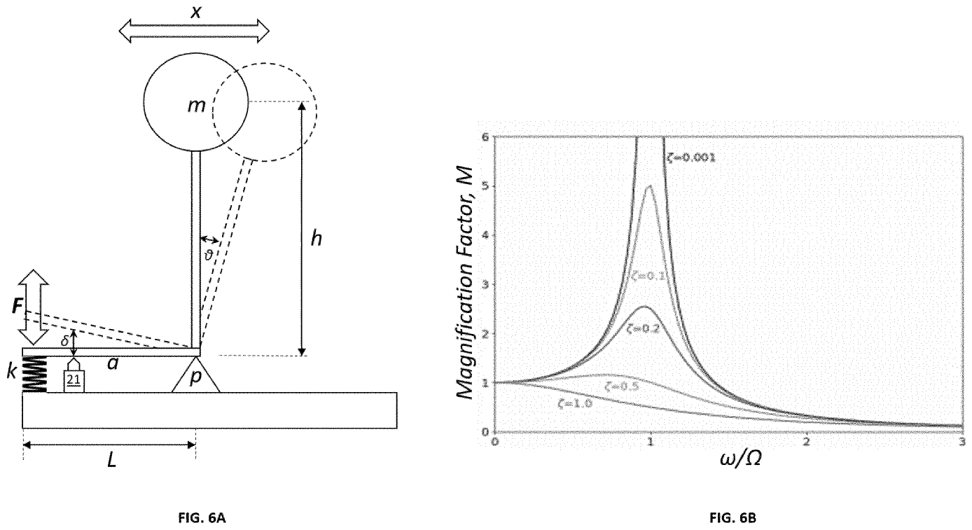

FIG. 6A shows a schematic representation of the basic elements of an arrangement of forces, motions and mass distributions according to an example of the invention. Here, the suspension assembly comprises one spring of spring constant k. The following analysis apples, mutatis mutandis, to other embodiments having suspension systems with additional springs such as shown in FIG. 1 and FIG. 3, FIG. 4 and FIG. 5.

Consider a pivoting anode assembly comprising a mass distribution that is equivalent to a centre of mass ‘m’ located at a distance ‘h’ from the pivot ‘p’ of the pivoting anode assembly. An anode surface part (not shown) defines a terminal end of the pivoting anode assembly distal from the pivot. A suspension assembly comprises a lateral arm ‘a’ of length ‘L’ which extends laterally from the longitudinal axis of the pivoting anode assembly at a point adjacent to the pivot ‘p’ located a longitudinal distance ‘h’ from the centre of mass ‘m’. The suspension assembly comprises a spring of spring constant ‘k’ configured to apply a restoring force to the distal end of the lateral arm ‘a’ a restoring force to urge the pivoting anode assembly towards a quiescent position (as shown) in which the pivoting anode assembly is static relative to the pivot. A displacer assembly (not shown) is configured to apply to the lateral arm ‘a’ a periodic displacing force ‘F to displace the pivoting anode assembly from the quiescent position. The result is that the position ‘x’ of the centre of mass ‘m’ of the pivoting anode assembly oscillates about the quiescent position in a motion transverse to its longitudinal axis in response to the periodic displacing force and the restoring force. This oscillates the anode surface part (not shown) at the distal end of the pivoting anode assembly transversely, in a reciprocating direction across the longitudinal axis. The nature of this oscillation, in relation to the centre of mass of the pivoting anode assembly, and the properties of the suspension assembly and the displacer assembly, are as follows.

Let the periodic displacing force ‘F take the following form:

$${F}_{1} = {F}_{0} sin ( ω t )$$

The torque applied to the pivoting anode assembly by this displacing force is:

$${T}_{1} = {F}_{1} L = {F}_{0} L sin ( ω t )$$

Let the spring of the suspension assembly be displaced (i.e., compressed or extended), by the displacing force, by a displacement ‘y’ causing the lateral arm ‘a’ to pivot, about the pivot point ‘p’ by a small angle θ, such that the spring force exerted by the spring upon the lateral arm is:

$${F}_{2} = k y = kL θ$$

The torque applied to the pivoting anode assembly by this spring force is:

$${T}_{2} = {F}_{2} L = k {L}^{2} θ$$

The centre of mass ‘m’ of the pivoting anode assembly is displaced by a lateral displacement ‘x’ in response to the net effect applied torques, T₁−T₂, such that an acceleration is experienced by it. This acceleration of mass corresponding to a force and, as a result of its longitudinal separation from the pivot point by a distance ‘h’, this amounts to a net torque:

$${T}_{3} = m \frac{{d}^{2} x}{{dt}^{2}} h = {mh}^{2} \frac{{d}^{2} θ}{{dt}^{2}} = {T}_{1} - {T}_{2}$$

Here, we use the fact that x=hθ for small θ. Thus, the equation of motion of the centre of mass ‘m’ of the pivoting anode assembly may be defined as:

$$m {h}^{2} \frac{{d}^{2} θ}{d {t}^{2}} = {F}_{0} L sin ( ω t ) - k {L}^{2} θ$$

In other words:

$$\frac{{d}^{2} θ}{d {t}^{2}} + ( \frac{k {L}^{2}}{{mh}^{2}} ) θ = ( \frac{{F}_{0} L}{{mh}^{2}} ) sin ( ω t )$$

If we reasonably assume, as a first approximation, that there exists a damping force (F_{d}) upon this system, which is proportional to the angular velocity of motion of the pivoting anode assembly, then the final equation of motion of the centre of mass ‘m’ of the pivoting anode assembly may be defined as:

$$\frac{{d}^{2} θ}{d {t}^{2}} + ( \frac{α}{{mh}^{2}} ) \frac{d θ}{d t} + ( \frac{k {L}^{2}}{{mh}^{2}} ) θ = ( \frac{{F}_{0} L}{{mh}^{2}} ) sin ( ω t )$$

Here, the term α is the damping constant of the damping force F_{d}=adθ/dt. The solution to this differential equation takes the form:

$$θ ( t ) = C sin ( ω t ) + D cos ( ω t ) = M {θ}_{0} sin ( ω t - φ )$$

Here, θ₀ is an amplitude factor and M is an amplitude magnification factor, where:

$$C = \frac{{θ}_{0} ( 1 - \frac{{ω}^{2}}{{Ω}^{2}} )}{{( 1 - \frac{{ω}^{2}}{{Ω}^{2}} )}^{2} + {( 2 ζ \frac{ω}{Ω} )}^{2}}$$

$$D = \frac{- {θ}_{0} ( 2 ζ \frac{ω}{Ω} )}{{( 1 - \frac{{ω}^{2}}{{Ω}^{2}} )}^{2} + {( 2 ζ \frac{ω}{Ω} )}^{2}}$$

$$M = \frac{\sqrt{{C}^{2} + {D}^{2}}}{{θ}_{0}} = \frac{1}{{( 1 - \frac{{ω}^{2}}{{Ω}^{2}} )}^{2} + {( 2 ζ \frac{ω}{Ω} )}^{2}}$$

Also,

$$ζ = ( \frac{α}{2 Ω {mh}^{2}} ) , Ω = ( \frac{{kL}^{2}}{{mh}^{2}} ) , {θ}_{0} = ( \frac{{F}_{0} L}{{mh}^{2} {Ω}^{2}} ) , φ = - \frac{D}{C} = \frac{2 ζ \frac{ω}{Ω}}{1 - \frac{{ω}^{2}}{{Ω}^{2}}}$$

The response of the pivoting anode assembly to the periodic forcing provided by the displacer assembly (F) depends on the ratio of the forcing frequency to the natural frequency, ω/Ω, and the damping term ζ. FIG. 6B illustrates the variation of the amplitude magnification factor, M, in response to variation in these terms. The resonant driving frequency, ω_{Res}, at which a maximum amplitude ‘M occurs (resonance) is a little less than the undamped natural frequency, Ω, and is given by:

$${ω}_{Res} = Ω \sqrt{1 - 2 {ζ}^{2}}$$

One can see that the natural frequency, Ω, and the resonant driving frequency, ω_{Res}, are each inversely proportional to the moment of inertia of the centre of mass of the pivoting anode assembly, which is given by: Iₘ=mh². According to the ‘Parallel Axis Theorem’, when system of mass ‘m’ is rotated about an axis offset from the centre of mass of the system by a displacement ‘h’, then the moment of inertia of the system may be defined as the sum of: (1) the moment of inertia (I_{CM}) of the system when considered about a first rotation axis passing through the centre of mass of the system, and (2) the moment of inertia (Iₘ=mh²) of the centre of mass of the system when considered about a second rotation axis parallel to the first rotation axis but offset from it by the distance ‘h’. In other words:

$$I = {I}_{C M} + {I}_{m} = {I}_{C M} + {mh}^{2}$$

The inventors have realised that by reducing the value of the offset distance ‘h’, the moment of inertia (I) of the pivoting anode assembly can be reduced thereby reducing the energy needed to oscillate the anode assembly, and that this also results in a much higher resonant driving frequency, ω_{Res}, at which a maximum amplitude ‘M’ occurs in the oscillating motion of the anode surface part across the impacting electron beam. This has been found to very effectively reduce the duration of time that the electron beam spot impacts upon a given surface point of the anode surface, thereby reducing the heating effect at the point of impact of the electron beam upon the anode material and permitting one to increase the electron beam intensity without overheating the anode surface. The resonant frequency and amplitude may be varied easily by an appropriate choice of string constant ‘k’ and/or lateral arm length ‘L’ of the suspension assembly, and/or by the amplitude (F₀) of the driving force applied by the displacer assembly.

In FIG. 1 the X-ray source includes a longitudinal displacer 29 coupled to a base end of the pivot and configured to adjustably displace the pivot, and the pivoting anode assembly 1 connected to the pivot, in a direction substantially parallel to a plane of oscillation of the anode surface part 2. The longitudinal displacer comprises an actuator (e.g., a piezoelectric element) configured to adjustably displace the pivoting anode assembly longitudinally. This displacement is controlled to adjustably displace the anode surface part 2 in a longitudinal direction towards or longitudinal away from the electron beam generator 5. The longitudinal displacer 29 comprises a position transducer configured to determine an angular position of the anode surface part (i.e., relative to the pivot) during oscillation thereof. This angular position corresponds to the angular position of the pivoting anode assembly. The longitudinal displacer is configured to adjustably displace the pivot 17, and thereby displace the pivoting anode assembly 1, in response to the determined angular position of the anode surface part to make substantially constant the separation between the electron beam generator 5 and the point of impact of the electron beam 3 upon the anode surface part during oscillation thereof. By keeping this separation constant, the result is that the point of impact of the electron beam 3 upon the anode surface part does not move along the electron beam axis 3. This keeps the focal point of the electron beam upon the anode surface and so eliminates changes in the size of the focal spot with angular position. The position transducer is configured to sense the angular position directly and this sensing may be provided by a sensor integrated into the pivot 17 such as a strain gauge attached to the flexing part (angular displacement) of the pivot or attached to an additional element that flexes with the angular displacement of the pivot.

The longitudinal displacer translates the angular position of the pivoting anode assembly into a correction to the longitudinal distance of the position of the point of impact of the electron beam upon the anode surface part, relative to the position of the point of impact when the pivoting anode assembly is in the quiescent position so as to keep this longitudinal distance constant

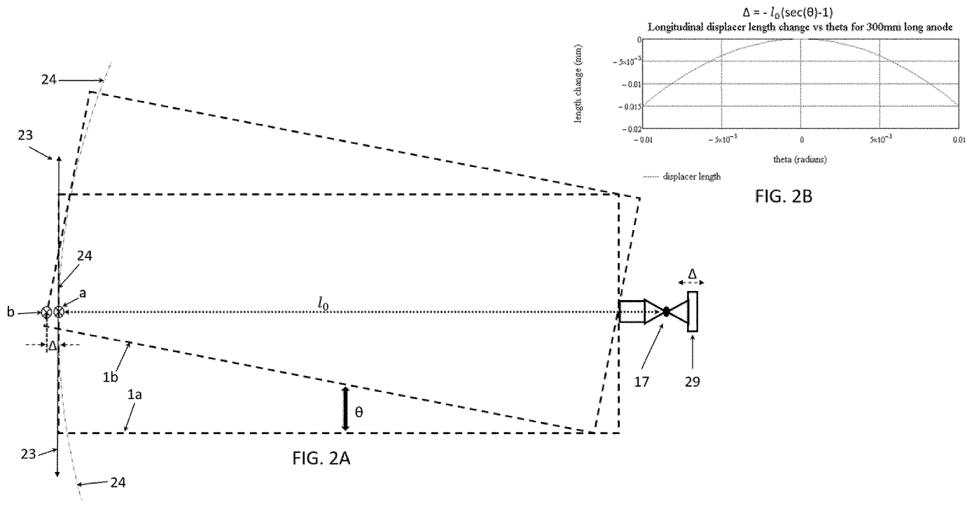

Referring to FIG. 2A, when the pivoting anode assembly is oscillating it periodically passes through a fiducial position 1a that it would have when quiescent. The longitudinal displacer 29 is configured to displace the pivot 17 in a first direction away from the electron beam generator 5 when the pivoting anode assembly has moved away from the fiducial position 1a to a position 1b with angular displacement θ. This serves to displace the pivoting anode assembly 1 away from the electron beam generator 5. Whereas the point of impact ‘a’ of the electron beam upon the anode surface is separated from the pivot 17 by a separation l₀ when in the quiescent position, the point of impact ‘b’ is separated from the pivot 17 by a separation l₀+Δ when the anode assembly 1 is at position 1b with angular displacement θ. This means that the impact point is closer to the electron gun and, therefore, will have moved out of the focal region of the electron beam. At this angular position, the prior point of impact ‘a’ has moved along a circular arc trajectory 24 away from the electron beam, due to the angular displacement of the anode assembly. This arcing motion causes the adjacent parts of the flat surface of the anode to tip towards the electron gun 5 and thereby move the impact point ‘b’ closer to the electron gun.

Accordingly, the longitudinal displacer applies a changing longitudinal displacement (Δ) to the pivoting anode assembly such that the rate of change of the longitudinal displacement (Δ) as a function of changing angular position is:

$$\frac{d l}{d θ} = l o \frac{sin θ}{{( cos θ )}^{2}}$$

$$\frac{d Δ}{d θ} = - \frac{d l}{d θ} = - {l}_{0} sec ( θ ) tan ( θ )$$

The effect is to counter-balance the changes in the longitudinal distance from the pivot 17 to the point of impact of the electron beam 3 upon the surface of the anode part 2 caused by the changing angular position of the pivoting anode assembly 1. The longitudinal displacer applies a changing longitudinal displacement (Δ) to the pivoting anode assembly at a given angular position (θ), as:

$$Δ = - lo ( sec θ - 1 )$$

This displacement is shown graphically in FIG. 2B in which example parameters are lo=300 mm and a maximum value of θ=0.01 radians.

The longitudinal displacer moves the anode surface 2 as a whole away from (or towards) the electron gun 5 as angular displacement of the anode assembly increases (or decreases) according to this relation.

The pivoting anode assembly 1 includes a coolant channel 31 configured for conducting coolant fluid (e.g., water) in a direction away from the pivot to the anode surface part 2. The coolant channel is also configured for conducting coolant fluid in a direction 32 towards the pivot such that the coolant fluid makes thermal communication with the underside of the anode surface (i.e., the side opposite the surface parts receiving electrons from the electron beam 3) thereby permitting it to remove heat from the anode surface part. A longitudinal separation 33 within the coolant channel defines a first conduit part in communication with the underside of the anode surface part for conducting a flow of coolant fluid towards the anode surface part, and a second conduit part for conducting a flow of that coolant fluid away from the anode surface. The first and second conduit parts may be separate pipes arranged in fluid communication at their respective terminal ends adjacent to the underside of the anode surface at which fluid flow reverse direction in passing from the first conduit part to the second conduit part whilst in thermal communication with the underside of the anode surface part.

The X-ray source of FIG. 1 and FIG. 3, FIG. 4 and FIG. 5 comprises a transverse displacer 37 (not shown in FIG. 3) including a stepper motor and a coupling 36 to the pivoting anode assembly configured to adjustably displace the pivoting anode assembly and the suspension assembly collectively in a direction 35 transverse to a plane of oscillation of the anode surface part. These components are marked as & in FIG. 1 and FIG. 3. The pivoting anode assembly is configured to oscillate about the quiescent position such that a point of intersection of the electron beam axis upon the anode surface part scans a substantially linear path across the anode surface part. The trajectory of the path of the focal spot of the electron beam upon the anode surface is constrained to be linear because the periodic displacement of the anode assembly is constrained to be in (or parallel to) a plane of oscillation containing the path of the focal spot of the electron beam upon the anode surface. The position of the anode assembly may be adjustably displaceable in a direction transverse to the plane of oscillation thereby to allow the oscillatory motion of the displaced anode assembly to be constrained to be in (or parallel to) a new plane of oscillation which is substantially parallel to the prior plane of oscillation. This allows the path of the focal spot of the electron beam to traverse a ‘fresh’ new surface region of the anode surface as and when the old surface region of the anode surface previously traversed by the focal spot of the electron beam becomes unsuitable for use e.g., due to accumulated electron impact damaged.

For this purpose, the X-ray source includes a transverse displacer 37 configured to adjustably displace the pivoting anode assembly 1 in a direction 35 transverse to a plane of oscillation of the anode surface part 2. The transverse displacer 37 comprises a stepper motor 36 configured to transversely displace the pivoting anode assembly 2 and the suspension assembly 19, 30 to different positions on a plane parallel to the anode surface part 2. This allows fresh areas of the anode surface to be used once particular areas have been consumed thereby reducing the frequency of anode replacement. This adjustably displaces the position of the anode assembly in a direction transverse to the plane of oscillation to an adjusted position allowing the anode assembly to oscillate in (or parallel to) a new plane of oscillation which is substantially parallel to the plane of oscillation from which displacement is made. The anode surface 2 is planar and inclined to the electron beam axis 3, being tiled towards the window 9. The transverse displacer is configured to adjustably displace the position of the anode assembly in a direction 35 similarly inclined, by pushing the parts of the X-ray source to which the pivot is mounted, along inclined sliding/bearing surfaces 32 which are substantially parallel to the anode surface. Consequently, the adjusted position of the anode assembly is such that the focal spot of the electron beam continues to coincide with the anode surface, and the distance between the electron source and the point of impact of the electron beam on the anode surface, remains substantially unchanged.

### EXAMPLES

### Example 1

Referring to FIG. 1 and FIG. 3, FIG. 4 and FIG. 5, a metallic anode 2 is impacted by an electron beam 3 from an electron gun 5. The electron gun 5 has focussing means within it that allows for the lateral size and energy of the electron beam to be changed to suit the required operating conditions. Typically, the electron beam might have an energy of 15 keV and a diameter when impacting the metallic anode 2 of 0.15 mm. These components are mounted in a vacuum chamber 7 that is connected to the vacuum of an XPS chamber. A thin window or barrier material 9 may be included to inhibit electrons backscattered from the metallic anode 2 from reaching the XPS chamber and the X-rays 11 generated by the impact of the electrons 3 on the metallic anode 2 pass through the window 9 and may be used for subsequence excitation of photoelectrons for the purpose of XPS analysis.

The metallic anode 2 is attached to the vacuum chamber 7 via a flexible bellows 13 which allows the anode to move relative to the chamber but excludes the ambient air so as to maintain a high or ultra-high vacuum environment suitable for operation of the electron gun 5. The metallic anode 2 has internal water channels 31 carry a flow of water 32 to the metallic anode 2 and these water channels are arranged extent to a point close to the tip of the pivoting anode assembly 1 to maximise the cooling efficiency between the area heated by the electron beam 3. The anode thereby is liquid cooled via these coaxial water channels that feed water to the tip of the pivoting anode assembly and returns the water to the outside world.

The metallic anode 2 is connected to a rigid structure 15a, 15b, attached to the vacuum chamber 7, via several elements. These are the pivot 17, the spring elements 19 of the suspension assembly and an actuator 21 of the displacer assembly. The pivot 17 (e.g., a hinge or flexure bearing) has its pivot axis orthogonal to the plane of the figure so that the motion of the tip of the anode assembly 1, and the metallic anode 2 at that tip, is as indicated by double headed arrow 23.

The spring elements 19 of the suspension assembly are compression coil springs in the present example, but can be any suitable means of providing a spring action. The actuator 21 is a piezo electric actuator that exerts a force between the rigid structure 15a, 15b and the pivot 17 mounted to the rear of the metallic anode 1. This actuator 21 exerts a displacement force related to an electrical signal from an electrical signal source 25 in substantially the direction of double headed arrow 27. This force is made periodic in time such that the anode assembly 1 is made to move the metallic anode 2 at its tip substantially along the path indicated by the double headed arrow 23.

For a slow rate of change of the displacement force 27, the movement along the path 23 will depend on the displacement force applied by the actuator 21 and the combined spring rates of the spring elements 19. If the rate of change of the displacement force 27 is steadily increased then the amplitude of the motion 23 will substantially increase as the resonant frequency of the anode assembly 1 supported by the pivot 17 and springs 19 is approached. This is the preferred operating condition, where a small exciting force from the actuator 21 leads to a large amplitude of motion 23.

The resonant frequency of a system as described depends on the moment of inertia of the masses supported by the pivot 17 and the spring rates of the supporting springs 19, and to a lesser extent the intrinsic spring rate of the actuator 21. The flexible bellows 13 will also contribute to the overall spring rate of the system. This means that the resonant frequency can be adjusted up or down by changing the spring constant of the spring elements 19 up or down respectively. A change of the spring constants of the springs may be achieved by simply replacing the springs.

Actuator 21 also preferably includes a transducer to allow real-time measurement of its length/extension. The signal from the transducer may be used as the control signal for the longitudinal actuator 29.

The effect of the motion of the surface of the metallic anode 2 along the path 23 is to spread out the area impacted by the electron beam 3 along a length determined by the length of path 23. Since the position of the electron beam 3 is fixed in space, in the frame of reference of the vacuum chamber 7, this means that the generated X-rays 11 appear to originate from the area of intersection of the electron beam 3 and the surface of the metallic anode 2. The heat to be dissipated in the metallic anode due to the impact of the electron beam is spread out over an area (A) equal to: A=W×L plus the area of the electron beam spot; where W is the width of the electron beam 3 in a direction out of the plane of the figure, and L is twice the amplitude (i.e., the ‘peak-to-peak’ displacement) of the motion 23. To take a typical example the electron beam diameter 3 might be 150 μm and twice the amplitude of the motion 23 (i.e., the ‘peak-to-peak’ displacement) might be 1 mm.

This means that the average power density in this elongated area will be 9.5 times lower. If the frequency of the motion was high enough then the electron beam power (this is the product of the electron accelerating voltage and the current in the beam) could be increased by approximately this factor for the same metallic anode 2 surface temperature. By this means the intensity of the X-ray beam 11, being proportional to the electron beam current, would be similarly increased. This then naturally leads to an increase in the XPS signal intensity with the commercial benefits that brings.

Due to the pivot 17 the path 23 of the anode tip 2 is a very shallow arc. For typical dimensions of the anode and the length of path 23 the depth of the arc is a few μm. In order to make constant the separation between the electron gun 5 and the point of impact of the electron beam on the anode surface 2, piezoelectric element 29 is extended and contracted according to the angular displacement of the anode assembly 1 from its quiescent (fiducial) position thereby rendering constant the separation in question. To this end, the piezoelectric element 29 is controlled using information about the extension/retraction state of the actuator 21 of the displacement assembly provided by the position transducer within the actuator 21.

The X-rays emitted along path 11 may pass to an X-ray mirror (not shown) which serves to refocus them onto a sample surface and reduce the energy spread of the X-rays to make them more suitable for XPS analysis. X-ray mirror assemblies are sensitive to the position of the X-ray source in a direction transverse to the path 11 indicated. Such small changes can result in the position of the refocused X-ray spot on the sample changing and also to the X-ray energy reflected changing with the amount of transverse displacement. Both of these effects can be detrimental to the quality of the subsequent XPS spectrum. The ability of the invention to compensate for movements of the X-ray source spot (i.e., the electron beam impact spot on the anode surface) caused by motion of the anode, means that the invention is able to greatly reduce variations in the intensity, energy or positional change of the reflected X-ray spot on the surface of a sample being irradiated with X-rays from the X-ray source, in use.

The extension/retraction state of the actuator 21 is directly correlated to the angular displacement of the pivoting anode assembly. For example, referring to FIG. 6a, an extension ‘δ’ of the actuator so as to result in the force ‘F’ at part of the pivoting anode assembly (or its suspension assembly) at a lateral distance ‘α’ from the pivot ‘p’ results in an angular displacement ‘0’ to the pivoting anode assembly, given by:

$$θ = {sin}^{- 1} ( \frac{δ}{a} )$$

The optimum operating conditions may be achieved at the highest vibrational frequency and amplitude. The pivoting anode assembly may comprise a bellows (e.g., an edge welded bellows) connected to the rest of the X-ray gun structure via an edge welded bellows that is employed to allow accurate positioning, using the transverse displacer described above, and alignment of the anode with the electron gun. The example of FIG. 5 shows a mechanical arrangement which differs from the arrangement of FIG. 1.

The main difference is that the pivot is in front of the displacement actuator 21 (21 is an insulated extension rod to the actuator 25 in FIG. 5), rather than behind it as in FIG. 1. FIG. 3A and FIG. 3B are simplified schematics of the principal elements of the design of FIG. 5. The difference is shown here as a change in the structure of the ‘suspension assembly’ 19, 30 and 30a. In this example, the base 42 of the pivoting anode assembly 1 is fixed to a ‘swinging basket’ type arrangement 30 and basket arms 30a are attached to the rest of the frame 15b via the pivot 17. It is suspended behind the pivot 17 and has springs 19 coupling it to the frame 15a either side of the pivot 17. These springs provide the return force to urge the ‘basket’ into the quiescent position which corresponds to the quiescent position of the anode assembly 1. By applying the periodic displacement force 27 to the base of the basket, at one side, the basket is forced to oscillate and thereby oscillate the anode assembly fixed to it. In the schematic of FIG. 3A, the displacement actuator 21 acts against the underside face of the ‘swinging basket’ arrangement 30. In the schematic of FIG. 3B, the displacement actuator 21 acts against the lateral side of the ‘swinging basket’ arrangement 30. An advantage of the arrangement is that the longitudinal actuator 29 is on the moving side of the pivot point 17 and so will not experience the “preload” spring force of the springs 19 and so could be a less robust (e.g., cheaper) actuator.

The main difference between the designs shown in FIG. 3 and FIG. 5 is that in FIG. 5 the plane containing the vibration direction 23 is orthogonal to the plane containing the electron beam and the outgoing x-ray beam rather than coplanar as in FIG. 3. This feature of the design shown in FIG. 5 may be preferable due to the angled end of the anode which would otherwise increase the longitudinal movement of the x-ray spot with the deviation from the quiescent position. This angled anode construction is convenient in the application of the X-ray gun of FIG. 5 when used in an X-ray monochromator. The anode surface in FIG. 3 is non-angled relative to the electron beam incidence direction.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

1. An X-ray source configured to generate X-rays by electron impact upon an anode comprising:
an electron beam generator for generating a beam of electrons directed along a beam axis;
a pivoting anode assembly comprising a pivot and an anode surface part mounted upon the pivot for receiving electrons in the beam of electrons therewith to generate X-rays;
a suspension assembly configured to apply to the pivoting anode assembly a restoring force to urge the pivoting anode assembly towards a quiescent position in which the anode surface part is static relative to the pivot;
a displacer assembly configured to apply to the pivoting anode assembly a periodic displacing force to displace the pivoting anode assembly from the quiescent position;
wherein the position of the anode assembly is configured to oscillate about the quiescent position in a motion transverse to the beam axis in response to the periodic displacing force and the restoring force thereby to oscillate the anode surface part transversely across the beam axis.

2. An X-ray source according to claim 1 wherein the pivoting anode assembly is configured to oscillate about the quiescent position such that a point of intersection of the electron beam axis upon the anode surface part scans a substantially linear path across the anode surface part.

3. An X-ray source according to claim 1 wherein the pivot comprises a single pivot axis such that the pivoting anode assembly is configured to pivot about the single pivot axis.

4. An X-ray source according to claim 3 wherein the spatial distribution of the mass of the pivoting anode assembly is asymmetrical with respect to the pivot axis.

5. An X-ray source according to claim 4 wherein the centre of mass of the pivoting anode assembly and the anode surface are located at opposite sides of the pivot.

6. An X-ray source according to claim 4 wherein the location of the centre of mass of the pivoting anode assembly is closer to the pivot than it is to the anode surface part.

7. An X-ray source according to claim 4 wherein the centre of mass of the pivoting anode assembly is located between the pivot and the anode surface part.

8. An X-ray source according to claim 1 wherein the pivoting anode assembly comprises a coolant channel configured for conducting coolant fluid in a direction away from the pivot to the anode surface part.

9. An X-ray source according to claim 8 wherein the coolant channel is configured for conducting coolant fluid in a direction towards the pivot and away from the anode surface.

10. An X-ray source according to claim 1 wherein the displacer assembly is configured to apply to the pivoting anode assembly said periodic displacing force with a periodicity corresponding to a resonant frequency of oscillation of the pivoting anode assembly.

11. An X-ray source according to claim 10 wherein the suspension assembly comprises one or more springs configured to apply the restoring force wherein the resonant frequency of oscillation is substantially proportional to the value of spring constant(s) of the one or more springs.

12. An X-ray source according to claim 1 wherein the anode surface part is electrically floating and held at a positive potential of not less than 5 kV.

13. An X-ray source according to claim 1 wherein the displacer assembly comprises a single actuator.

14. An X-ray source according to claim 13 wherein the actuator comprises a piezo-electric actuator.

15. An X-ray source according to claim 1 wherein said pivot comprises one or more flexure bearings configured to flex about a pivot axis of the pivoting anode assembly.

16. An X-ray source according to claim 1 wherein the displacer assembly comprises a transverse displacer configured to adjustably displace the pivoting anode assembly and the suspension assembly collectively in a direction transverse to a plane of oscillation of the anode surface part.

17. An X-ray source according to claim 1 comprising a longitudinal displacer configured to adjustably displace the pivoting anode assembly in a direction substantially parallel to a plane of oscillation of the anode surface part to adjustably displace the anode surface part in a direction selectively longitudinal towards or longitudinal away from the electron beam generator.

18. An X-ray source according to claim 1 wherein the longitudinal displacer comprises a position transducer configured to determine a position of the anode surface part during oscillation thereof, and the longitudinal displacer is configured to adjustably displace the pivoting anode assembly in response to the determined position of the anode surface part to make substantially constant the separation between the electron beam generator and the point of impact of the electron beam upon the anode surface part during oscillation thereof.

19. An X-ray source according to claim 1 wherein the displacer assembly is configured to apply to the pivoting anode assembly the periodic displacing force to apply a torque to the pivoting anode assembly at a location thereon between the anode surface part and the pivot.

20. An X-ray source according to claim 1 wherein the displacer assembly is configured to apply to the pivoting anode assembly the periodic displacing force to apply a torque to the pivoting anode assembly at a location thereon wherein the pivot is located between said location of the applied torque and the anode surface.

21. An X-ray monochromator comprising the X-ray source according to claim 1.

22. An anode device for an X-ray source having an electron beam generator for generating a beam of electrons directed along a beam axis for use in generating X-rays by electron impact upon the anode device, the anode device comprising:
a pivoting anode assembly comprising a pivot and an anode surface part mounted upon the pivot for receiving electrons in a beam of electrons therewith to generate X-rays;
a suspension assembly configured to apply to the pivoting anode assembly a restoring force to urge the pivoting anode assembly towards a quiescent position in which the anode surface part is static relative to the pivot;
a displacer assembly configured to apply to the pivoting anode assembly a periodic displacing force to displace the pivoting anode assembly from the quiescent position;
wherein the position of the anode assembly is configured to oscillate about the quiescent position in a motion transverse to the beam axis in response to the periodic displacing force and the restoring force thereby to oscillate the anode surface part transversely across the beam axis.

23. A method to generate X-rays by electron impact upon a surface part of an anode, the method comprising:
generating a beam of electrons directed along a beam axis;
receiving electrons from the beam of electrons at an anode surface part thereby generating X-rays, wherein the anode surface part is mounted upon a pivoting anode assembly which comprises a pivot and which is mounted upon a suspension assembly;
applying to the pivoting anode assembly a restoring force via the suspension assembly to urge the pivoting anode assembly towards a quiescent position in which the anode surface part is static relative to the pivot;
applying to the pivoting anode assembly a periodic displacing force to displace the pivoting anode assembly from the quiescent position;
whereby the position of the anode assembly is oscillated about the quiescent position in a motion transverse to the beam axis in response to the periodic displacing force and the restoring force, thereby oscillating the anode surface part transversely across the beam axis.
